(19) United States
(12) Patent Application Publication
(10) Pub. No.: US 2025/0210982 A1
(43) Pub. Date: Jun. 26, 2025

(54) POWER CONDITIONING FOR HIGH-SPEED MACHINE GENERATOR

(71) Applicant: GEORGIA TECH RESEARCH CORPORATION, Atlanta, GA (US)

(72) Inventors: Deepak DIVAN, Marietta, GA (US); Rajendra Prasad KANDULA, Smyrna, GA (US); Vikram Roy CHOWDHURY, Atlanta, GA (US)

(21) Appl. No.: 18/850,496

(22) PCT Filed: Mar. 27, 2023
(86) PCT No.: PCT/US2023/016403

§ 371 Date: Sep. 24, 2024

Related U.S. Application Data
(60) Provisional application No. 63/323,741, filed on Mar. 25, 2022.

(51) Int. Cl. H02J 1/02; H02J 1/06; H02K 47/04; H02P 11/04; H03H 7/01

(52) U.S. Cl. CPC H02J 1/02; H02J 1/06; H02K 47/04; H02P 11/04; H03H 7/0115; H02P 2201/03

(57) ABSTRACT

An exemplary power conditioning method and system are disclosed using a power converter in combination with a diode bridge rectifier and a series transformer in which the power converter is configured to inject VARs to a high-speed rotating machine to compensate for the machine reactance. By injecting VARs into the machine using the power converter through the series transformer, the power converter can be fractionally rated, in terms of power rating, to a lower power rating which would otherwise have to be higher due to the reactance requirements due to its high-frequency input. And additionally, because of the lower power rating, the transformer can be beneficially rated for the corresponding power level of the machine. The operation of the diode bridge rectifier and a transformer does not add to the complexity of the control of the system or that of the power converter.

### RELATED APPLICATION

This International PCT application claims priority to, and the benefit of, U.S. Provisional Patent Application No. 63/323,741, filed Mar. 25, 2022, entitled “Power Conditioning for High-Speed Permanent Magnet Generators,” which is hereby incorporated by reference herein in its entirety.

### BACKGROUND

A high-speed turbine system that drives a permanent magnet generator may have the generator operating at high frequencies in the kilohertz range. A power converter would be employed to change the high-frequency AC output of the generator to a DC output. These machines have found usage in a wide variety of applications, ranging from aerospace to distributed generation.

Inverters are typically designed to switch at multiples of the fundamental frequency of the machine. At the high frequency of operations, one approach would be to provide an inverter that employs wide bandgap materials, such as silicon carbide, to provide a silicon-carbide-based inverter, which can be costly. Another approach using conventional power switching devices would be to rate the converter for such machines at a higher power rate. While the inductance of the machine can be made low, at such high operating frequencies, the resulting impedance could still be high, which can lead to reactive power loss, reduced operating power factor of the machine, reduced power delivered at a given current level, and the limited maximum power that can be transferred. The higher power rating would address the reactive power loss.

There is significant interest in improving the operation of high-speed turbines that can drive permanent magnet generators and other high-speed machine generators.

### SUMMARY

An exemplary power conditioning method and system are disclosed using a power converter in combination with a diode bridge rectifier and a series transformer in which the power converter is configured to inject VARs to a high-speed rotating machine to compensate for the machine reactance. An example of a high-speed rotating machine is a high-speed turbine driving a permanent magnet generator, among other machines described herein. By injecting VARs into the machine using the power converter through the series transformer, the power converter can be fractionally rated, in terms of power rating, to a lower power rating which would otherwise have to be higher due to the reactance requirements due to its high-frequency input. And additionally, because of the lower power rating, the transformer can be beneficially rated for the corresponding power level of the machine. The operation of the diode bridge rectifier and a transformer does not add to the complexity of the control of the system or that of the power converter.

In some embodiments, the exemplary power conditioning unit comprises a single or multi-turn coaxial winding transformer to inject leading or lagging VARs. The exemplary power conditioning unit may be employed with a power converter (e.g., an inverter) that can employ ¼ the power rating of a conventional solution, offering size, cost, and efficiency advantages.

In an aspect, a system is disclosed comprising a rectifier configured to couple to each phase output of a high-speed machine generator to convert AC electrical power outputted from the machine to a DC output; and a series compensated power conditioner coupled to the diode bridge and the high-speed machine generator, the series compensated power conditioner comprising a power converter coupled in series to the high-speed machine generator through a series transformer to inject reactive power (VARs) into each phase output of the high-speed machine generator.

In some embodiments, the series compensated power conditioner provides leading reactive power to the high-speed machine to reduce reactive power loss.

In some embodiments, the system further includes a controller configured to direct the power converter to inject a leading voltage to the machine reactance for each phase output of the high-speed machine generator.

In some embodiments, the series transformer comprises a coaxial winding transformer (CWT), the coaxial winding transformer includes a multi-turn winding enclosed by a single-turn primary winding structure.

In some embodiments, each phase output of the power converter is connected in series to the multi-turn winding, and each phase output of the high-speed machine generator is connected in series to the rectifier through the single-turn primary winding structure.

In some embodiments, the rectifier comprises a diode bridge rectifier.

In some embodiments, the rectifier further comprises an LC filter.

In some embodiments, the controller is configured to generate a notched pulse-width modulation (PWM) output to reduce harmonic distortion for pre-defined harmonics.

In some embodiments, the high-speed machine generator is selected from the group consisting of a wound-field synchronous machine, a switched reluctance machine, a permanent magnet machine, and a permanent magnet synchronous motor machine.

In some embodiments, the high-speed machine generator is a single-phase output machine.

In some embodiments, the high-speed machine generator is a three-phase output machine.

In another aspect, a method is disclosed comprising converting, via a rectifier, AC electrical power outputted from each phase output of a high-speed machine generator to a DC output; and injecting reactive power (VARs) through a series transformer into each phase output of the high-speed machine generator via a series compensated power conditioner coupled to the rectifier and the high-speed machine generator, the series compensated power conditioner comprising a power converter coupled in series to the high-speed machine generator through the series transformer.

In some embodiments, the series compensated power conditioner provides leading reactive power to the high-speed machine to reduce reactive power loss.

In some embodiments, the reactive power is injected as a leading voltage to the machine reactance for each phase output of the high-speed machine generator.

In some embodiments, the series transformer (e.g., CWT) includes a multi-turn secondary winding having N windings that is proximal to a primary winding structure having less than N windings.

In some embodiments, each phase output of the power converter is connected in series to the secondary multi-turn winding, and each phase output of the high-speed machine generator is connected in series to the rectifier through the primary winding structure.

In some embodiments, the rectifier comprises a diode bridge rectifier and an LC filter.

In some embodiments, the leading reactive power is injected as a pulse-width-modulation (PWM) output or a notched PWM output.

In some embodiments, the high-speed machine generator is selected from the group consisting of a wound-field synchronous machine, a switched reluctance machine, a permanent magnet machine, and a permanent magnet synchronous motor machine.

In some embodiments, the high-speed machine generator is a single-phase output machine or a three-phase output machine.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 shows an example power conversion and conditioning system for a high-speed machine generator configured to inject a series of VARs to the high-speed machine generator to compensate for machine reactance in accordance with an illustrative embodiment.

FIG. 2A shows an example of a high-speed machine generator and the example power conversion and conditioning system of FIG. 1 to inject a series of VARs to the high-speed machine generator in accordance with an illustrative embodiment.

FIG. 2B shows examples of the injected voltage operation in relation to other high-speed machine generator operations.

FIGS. 2C, 2D, and 2E, respectively, show the total harmonic distortion performance of the power conversion system of FIG. 1, the rectifier terminal voltage of the power conversion and conditioning system, and the system's maximum obtainable power.

FIG. 3 shows an example series transformer that may be used to couple the power conversion and conditioning system to the high-speed machine.

FIG. 4A shows an example of notched PWM output that can be generated by the example power conversion and conditioning system to inject VARs to the high-speed machine generator in accordance with an illustrative embodiment.

FIG. 4B shows examples of the injected voltage operation via the notched PWM in relation to other high-speed machine generator operations.

FIGS. 4C, 4D, and 4E, respectively, show the total harmonic distortion performance of the power conversion and conditioning system of FIG. 1 using the notched PWM, the rectifier terminal voltage of the power conversion and conditioning system, and the system's maximum obtainable power.

FIG. 5A shows an example of the high-speed machine generator of FIG. 2 coupled with a conventional power conversion system.

FIGS. 5B, 5C, 5D, and 5E, respectively, show the conventional power conversion system operation without reactive power injection, the total harmonic distortion performance of the power conversion system, the rectifier terminal voltage of the power conversion system, and the system's maximum obtainable power.

### DETAILED SPECIFICATION

To facilitate an understanding of the principles and features of various embodiments of the present invention, they are explained hereinafter with reference to their implementation in illustrative embodiments.

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the nth reference in the list. All references cited and discussed in this specification are incorporated herein by reference in their entirety and to the same extent as if each reference was individually incorporated by reference.

### Example System

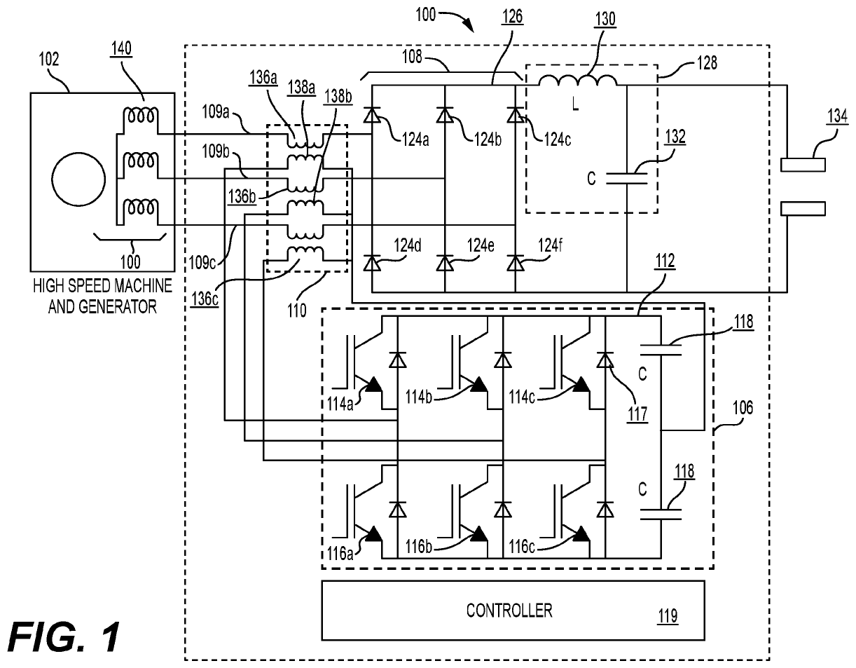

FIG. 1 shows an example power conversion and conditioning system 100 for a high-speed machine generator 102 (shown as motor 102a and generator 102b) configured to inject a series of VARs to the high-speed rotating machine to compensate for machine reactance in accordance with an illustrative embodiment. In the example shown in FIG. 1, the power conversion and conditioning system 100 includes a power converter 106 (shown as inverter 106), as a series compensated power conditioner, and an AC/DC converter 108 (shown as a diode bridge rectifier 108) that are coupled to the generator outputs 109 (shown as 109a, 109b, 109c) of the high-speed machine generator 102 through a set of transformers 110. The diode bridge 108 and transformers 110 collectively form a series compensator as a series-compensated power conditioning component that is configured to increase the power obtainable from the high-speed machine generator and thus drive its rated value. Stated differently, the series compensator can inject a series of reactive power (VARs) into the high-speed rotating machine 102 to compensate for the machine's reactance.

Examples of high-speed machine generator 102 include a permanent magnet synchronous motor machine (PMSM). The generator may include a permanent magnet rotor and three-phase stator windings, which can terminate at the generator terminals. Other examples of high-speed machine generators include a wound-field synchronous machine, switched reluctance machine, a permanent magnet machine, or other types of machines.

In FIG. 1, the power converter 106 is coupled between the generator terminals 109 and a DC link 112 and is configured as a three-phase bridge inverter. The generator's terminals 109 are connected to a series-connected inverter per phase. While the example is described in connection with three-phase AC power, the machine/generator may alternatively be configured to output one-phase, two-phase AC power, six-phase AC power, etc., for the corresponding power conditioning system.

In the example shown in FIG. 1, the power converter 106 includes six switches 114, including a set of upper switches 114 (shown as 114a, 114b, 114c) and a set of lower switches 116 (shown as 116a, 116b, 116c) connected across a DC link 120. Each switch 114, and 116 of the power converter 106 includes a controllable solid-state device such as an IGBT or a MOSFET and an anti-parallel diode 117 across the solid-state device. DC link capacitors 118 are additionally coupled across the DC link 112 to produce a low source impedance for the power converter and to reduce voltage ripple on the DC link 112. The switches 114, and 116 are controlled by a controller 119. The controller 119 may be implemented in software, hardware, or any combination thereof.

The generator 120 of the machine 102 can generate a voltage, as the back EMF, behind reactance 122. The voltage generated at the generator can be referred to as the generator voltage or generator emf, and the voltage at the terminals of the power converter 106 can be referred to as the power converter terminal voltage.

As noted above, the series compensator includes a diode bridge 108 and a set of series transformers 110. In this example, the diode bridge 108 includes six diodes 124 (shown as 124a, 124b, 124c, 124d, 124e, 124f) on a second DC link 126 that outputs to the bridge output 134 through an LC filter 128 comprising an inductor 130 and capacitor 132. The set of transformers 110 is configured with a set of series transformers that couples to three primary windings 136 of the generator 102 and the diode bridge at its primary windings 136 (shown as 136a, 136b, 136c) (e.g., having at least one turn) and to the three-phase power converter through its secondary windings 138 (shown as 138a, 138b) (e.g., having multiple turns). In some embodiments, the series transformers 110 are configured as coaxial winding transformers.

### Example VAR Injection Operation Using Power Conditioning Unit

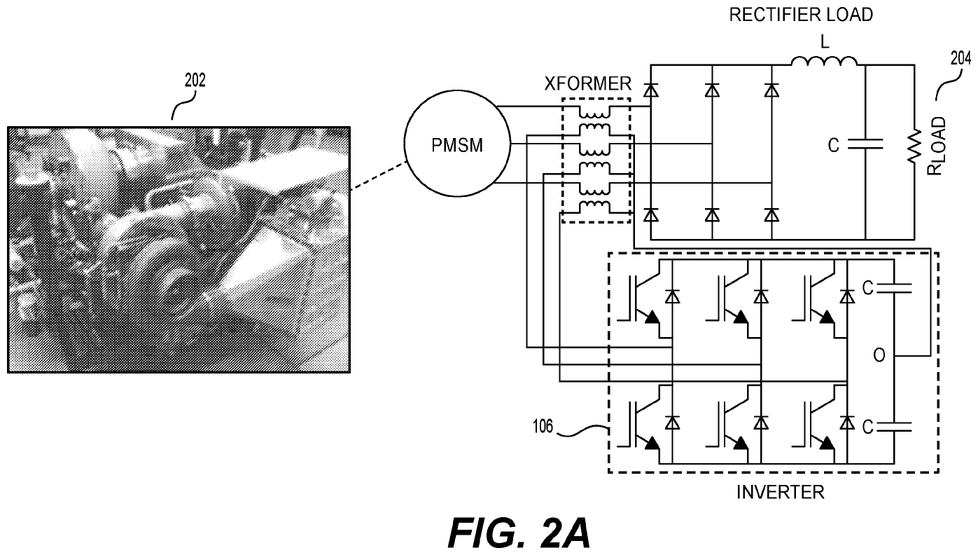

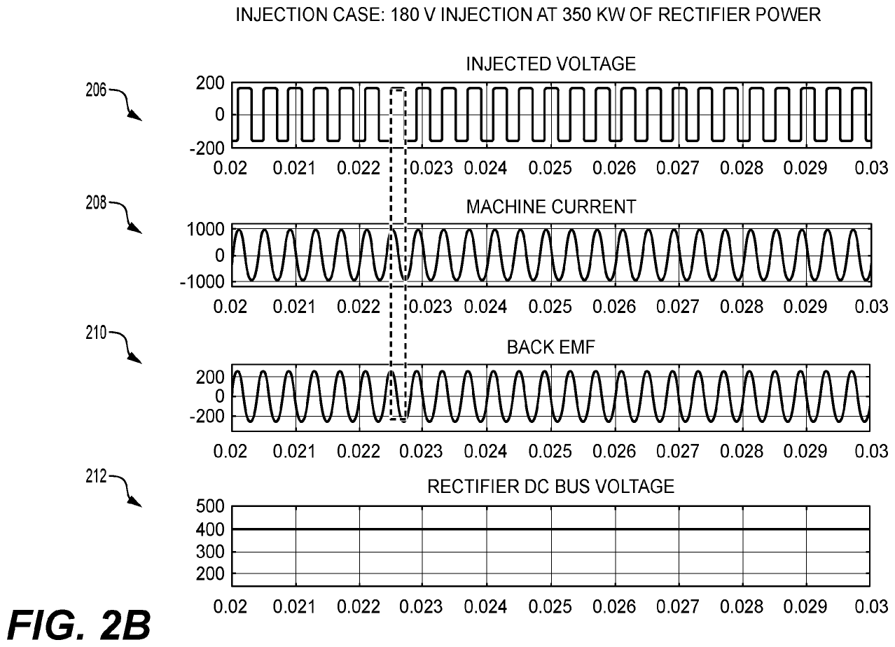

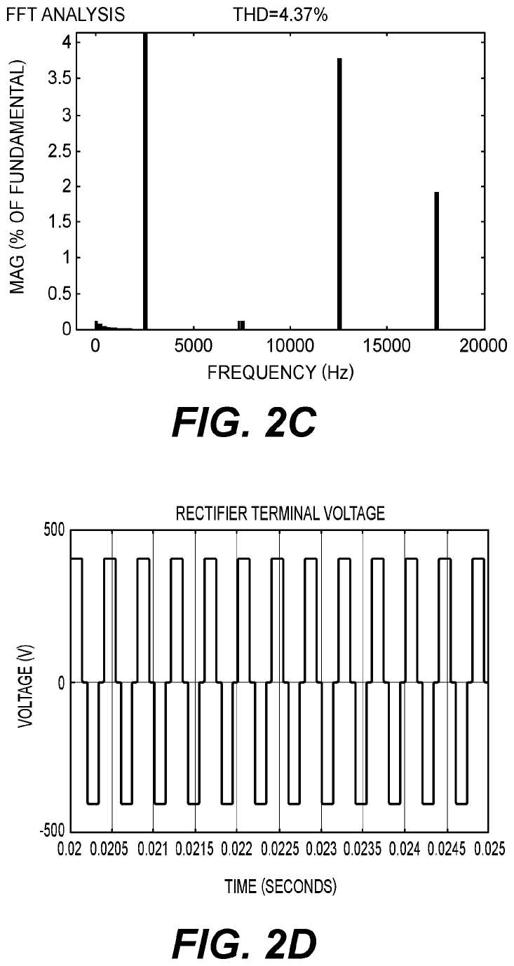

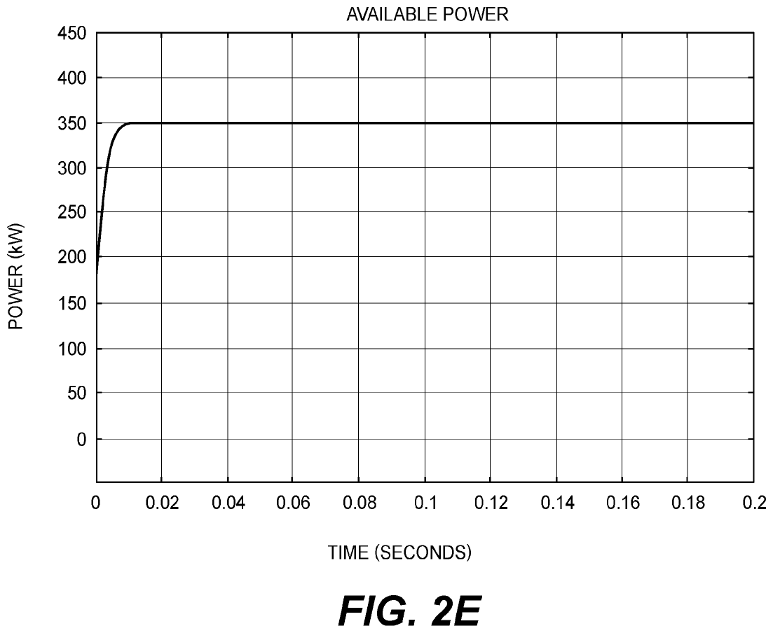

FIG. 2A shows an example of a high-speed motor/generator machine 202 having a high-speed turbine driving a permanent magnet generator. The high-speed turbine and permanent magnet generator machine 202 can be configured to operate with the exemplary power conditioning system and power converter of FIG. 1.

An example specification for a high-speed turbine driving permanent magnet generator may have the turbine operating at a spinning speed of 75,000 rpm (75k RPM) to generate hundreds of kilowatts of power. The turbine may be operating or rated for 10k RPM, 11k RPM, 12k RPM, 13k RPM, 14k RPM, 15k RPM, 16k RPM, 17k RPM, 18k RPM, 19k RPM, 20k RPM, 21k RPM, 22k RPM, 23k RPM, 24k RPM, 25k RPM, 26k RPM, 27k RPM, 28k RPM, 29k RM, 30k RPM, 31k RPM, 32k RPM, 33k RPM, 34k RPM, 35k RPM, 36k RPM, 37k RPM, 38k RPM, 39k RPM, 40k RPM, 41k RPM, 42k RPM, 43k RPM, 44k RPM, 45k RPM, 46k RPM, 47k RPM, 48k RPM, 49k RPM, 50k RPM. In some embodiments, the turbine is operating at greater than 50k RPM. In some embodiments, the turbine is operating at greater than 100k RPM. This type of machine can be used in a wide variety of applications, ranging from aerospace to distributed generation.

In one example, the generator (e.g., 202) may be a 4-pole permanent magnet (PM) machine (e.g., 102) that would generate a nominal output at 2500 Hertz electrical frequency. The maximum power that such a machine (e.g., 202) can deliver, into say, a resistive load, may be limited by the voltage drop across the machine reactance (e.g., shown as 140 in FIG. 1). This voltage drop can reduce (i) the operating power factor of the machine and (ii) the power delivered at a given current level as well as limit the maximum power that can be transferred. An example is a PM generator with a back EMF of 183.7 volts line-neutral at 2500 Hertz with a machine inductance of 14 microhenries and a winding rated to carry 660 Amperes. At these operating points, the generator can only deliver about 220 kW into a resistive load, as opposed to the 363 kW that it could deliver if the inductance did not limit the power flows. This is a significant penalty (40% reduction) on the capability of such a generator. A similar penalty would apply in the case that the generator output was rectified to a DC voltage for power delivery to a DC load.

The exemplary method and power conditioning system can extract higher power from the machine by compensating the machine VARs using a power converter to supply leading VARs, e.g., at 2500 Hz in the above example, to inject a series injection of VARs to compensate for the machine reactance. In the example shown in FIGS. 1 and 2, the power conditioning unit employs a series-connected power converter per phase (e.g., a series-connected inverter per phase). The power converter 106 may be configured to float at the terminal voltage and inject the desired leading (or lagging) voltage to increase or reduce the generator current. Such a power converter would have to carry a very high current (660 Amperes in the above-referenced example), which may result in high switch losses. A single-phase configuration may also result in a high ripple current in the DC bus capacitance, increasing the requirement for the rating.

An alternate approach is to use a series transformer with a three-phase power converter (e.g., inverter) connected to the three primary windings that, at the high frequency and high current, may be able to achieve low losses and low leakage inductance. The exemplary power conditioning unit may employ a coaxial winding transformer (CWT) with a single turn primary [4], which in turn may be connected to a fractionally rated power converter configured to switch at relatively low frequency, e.g., around 2.5 kHz to 7.5 kHz. The CWT may have an N: 1 turns ratio to handle a high current (say 660 Amperes) on one winding and convert that to a lower current on the second winding. The design of the CWT may also achieve extremely low leakage inductance. Further, at the 2.5 kHz frequency, the CWT could be 1/40^{th} the size of an equivalent 60 Hertz transformer, making it very efficient and cost-effective.

The CWT is configured to insert voltage on a line-neutral or line-line voltage, although it is postulated that the line-line configuration will provide lower core and copper losses. The design example shown herein can use a high-frequency core material, such as a nano-crystalline core, amorphous iron core, or thin silicon-steel laminations suitable for operation at 2.5 kHz, most likely configuring the high current winding as a single-turn winding made from continuous copper tube. This single-turn winding will carry the high machine current and will insert the needed voltage for series VAR compensation. The inside winding consists of multiple turns and is generally high-voltage, low-current winding. The coaxial design can provide extremely low leakage inductance between the primary and secondary windings. CWTs lend themselves to operation at high current levels, with prior CWTs built to handle thousands of amperes, both at low and high frequencies.

The power converter as an inverter could be a voltage source inverter (or current source inverter, CSI), generally switching at the generator output electrical frequency, in this case, 2500 Hertz. The low switching frequency reduces switching losses, as compared to an inverter switching at 25-50 kHz. In the scenario in which the motor currents have higher levels of harmonics due to the inverter switching, additional pulses can be introduced in the inverter switching to eliminate the lowest-order harmonics. Alternative advanced PWM strategies can also be used to eliminate harmonics. The inverter can be a standard system design but configured with customized programmed PWM to eliminate the low-order harmonics. This may be an iterative process and could benefit from the use of advanced techniques such as Neural Nets or a gradient method to find the lowest dissipation point, as well as various AI/ML techniques described herein.

The exemplary system can also allow the re-optimization at the machine level to increase the back EMF by, say, 25%, allowing further reduction in winding currents and reduction in losses. An optimal integrated solution needs to be developed to provide in the range of 600-700 volts DC from no load to full load, with the ability to regulate the DC voltage over a small range if needed. This will dramatically reduce the complexity and cost of the overall implementation and make the turbine generator more universally applicable.

In contrast, conventional approaches may use an inverter (e.g., 106) that switches at high frequency to connect to the machine. The inverter 106, at least in principle, can allow the generation of an arbitrary voltage and phase angle at 2500 Hz. This allows control of P and Q independently, allowing extraction of a higher power from the generator. The challenge is often with the low inductance of the machine. To keep the current ripple at moderate levels, the system may employ extremely high switching frequencies. For instance, for a machine with 14 μHof inductance, as is the case of this example, with 500 volts DC bus (e.g., 112) on the inverter, the system may employ switching at 50-100 kHz switching frequency. If this were achieved with wide bandgap devices (e.g., SiC), the system would be submitted to a dv/dt levels of >50 kV/μs that may generate associated EMI and/or insulation failure issues, as well as additional losses. And, to extract 350 kW power from this generator configuration, the system may employ a ˜500 kV A inverter switching at ˜50 kHz.

In addition to being technically challenging, the approach can have other issues, such as cost and system efficiency. For example, the cost of a high-frequency inverter rated at 500 kVA can be high, and the efficiency may be poor due to switching losses in the devices.

### Example Coaxial Winding Transformer

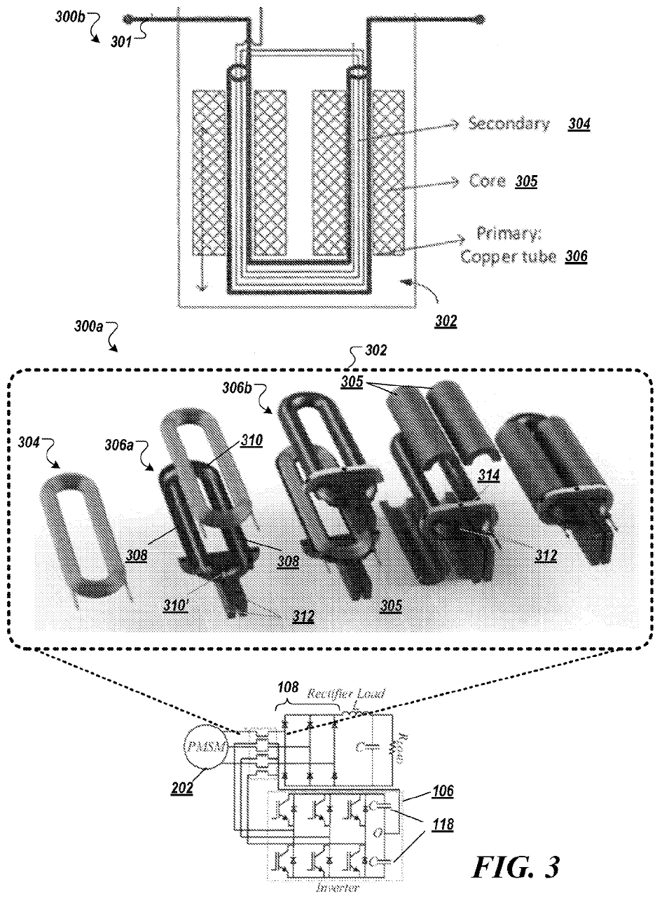

FIG. 3 shows, in an assembly view 300a and cross-sectional view 300b, a coaxial winding transformer (CWT) 302 having multi-turn winding 304 enclosed by a single-turn structure. In the example, the turns of the secondary winding 304 are coaxially located with the main (or primary) conductor 301 in a core 305. The core 305 can be a nano-crystalline core, amorphous iron core, thin silicon-steel laminations, silicon steel core, or other core that is equivalent or suitable for the application. A U-shaped or oval-shaped tube 306 can provide the primary winding (and a portion of the main conductor 301 to the high-speed machine generator 102) through connections at opposite ends. The U-shaped or oval-shaped tube 306 can be copper or other appropriate conductive material. The turns of the secondary winding 304 can pass through the inside the copper tube 306 (e.g., with a turns ratio of 1:50) and connects to the power converter 106. The coaxial configuration reduces the levels of leakage flux in the CWT 302.

In diagram 300a, the oval-shaped tube 306 includes two straight sections 308 between rounded ends 310 (shown as 310 and 310′) and is split along the length of the tube to facilitate insertion of the secondary winding 304 between both halves 306a and 306b of the oval-shaped tube 306. In one of the rounded ends 310′, the oval-shaped split tube 306 is cut to form a single-turn primary winding for the CWT 302. Connection plates 312 are mounted to both halves of the split tube 306a and 306b on opposite sides of the cut in the rounded end 310. As can be understood, the two halves of the oval-shaped tube 306a and 306b are mirror images of each other that can be positioned to form the completed oval-shaped split tube 306.

For assembly, a multi-turn winding can be formed for the secondary winding 304 of the CWT 302. The secondary winding 304 is placed in one-half of the oval-shaped split tube 306a. The leads for the secondary winding can be passed through openings in one of the rounded ends 310′ of one-half of the oval-shaped split tube 306a. For example, openings can be formed on opposite sides of the cut end of the half tube 306a, with the connection plates 312 between the two openings. The secondary winding leads 304 can pass through the openings for connection to the switching circuitry, e.g., of the inverter 106. A protective sleeve can be provided around the leads passing through the openings to provide additional insulation and wear protection. With the winding 304 positioned in the half tube 306a, the other half tube 306b can be aligned over tube half 306a so that the secondary winding 304 is surrounded by the oval-shaped split tube 306. The connection plates 312 of each tube half can be configured to attach together to hold the halves of the oval-shaped split tube 306 in alignment around the secondary winding 304. For example, corresponding connection plates 312 can be secured together using fasteners (e.g., bolts or screws).

Mounting braces 314 can also be included to hold the oval-shaped split tube 306 in alignment and secure the cores 305 around the straight sections 310 of the oval-shaped split tube 306. The mounting braces 314 can be made from insulating material with sufficient strength to hold the cores 305 in position on the oval-shaped split tube 306. The mounting braces 314 can be fixed in position at both ends of the cores 305 using fasteners (e.g., nuts and bolts) extending through the center and outside both sides of the oval-shaped split tube 306 to secure two halves together. The construction of the CWT 302 allows it to be immersed in oil for cooling during operations. Holes or openings can be provided in tube 306 to allow oil to flow inside tube 306 around the secondary winding 304.

The machine (202) (along with series CWT 302) may be connected to a 3-phase diode rectifier bridge (e.g., using silicon carbide (SiC) diodes) with a capacitor filter 118. The inverter 108 and CWT 302 may be used to inject a controllable leading voltage that cancels a portion of the voltage drop due to the machine's reactance (e.g., 140). For instance, to cancel 40% of the voltage drop across the machine reactance, the inverter 106 would be rated at around 150 kVA (30% of the other option) and would be switching at 7.5 kHz with a straightforward control strategy and with significantly lower losses. Such an approach could allow the conversion of the turbine to a DC output. Whereas the inverter 106 would inject leading VARs to increase the power delivered from the generator under normal conditions, it could also inject lagging VARs to significantly limit the current that could flow under fault conditions, simplifying the protection requirements.

Referring back to FIG. 1, the power converter 106 may inject a square wave 202 (shown as injected voltage 202) at the machine frequency (2500 Hz) in series with the windings using a coaxial winding transformer 302. The CWT 302 includes the single-turn copper tube 306 for the high current winding, with a multiple-turn winding 304 inside. CWTs rated at 2500 Amperes have been built and are commercially available. As an example, a 6:1 turns ratio could be used. As explained earlier, the (machine (e.g., 102, 202) and CWT 302) can directly feed into a diode capacitor rectifier. The resistor 204 models the load on the system.

### Experimental Results and Additional Examples

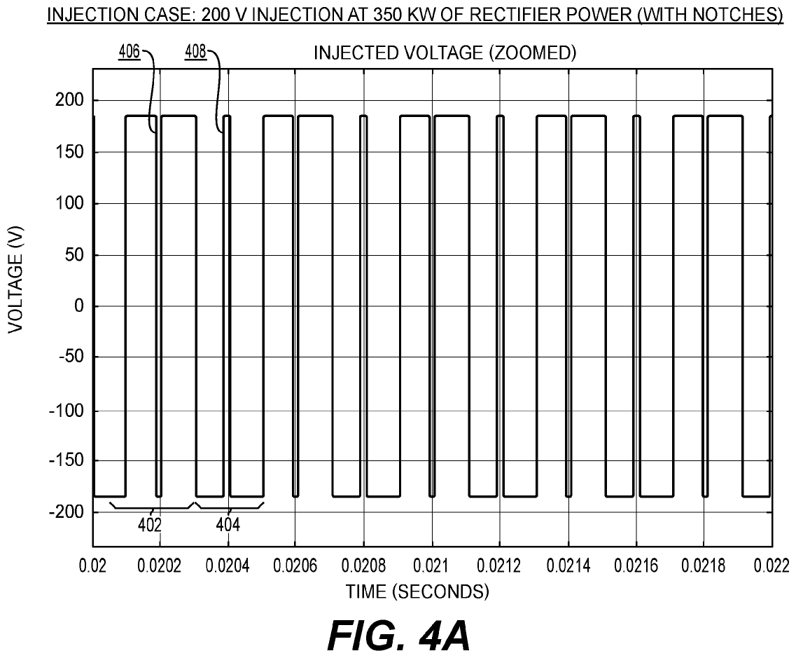

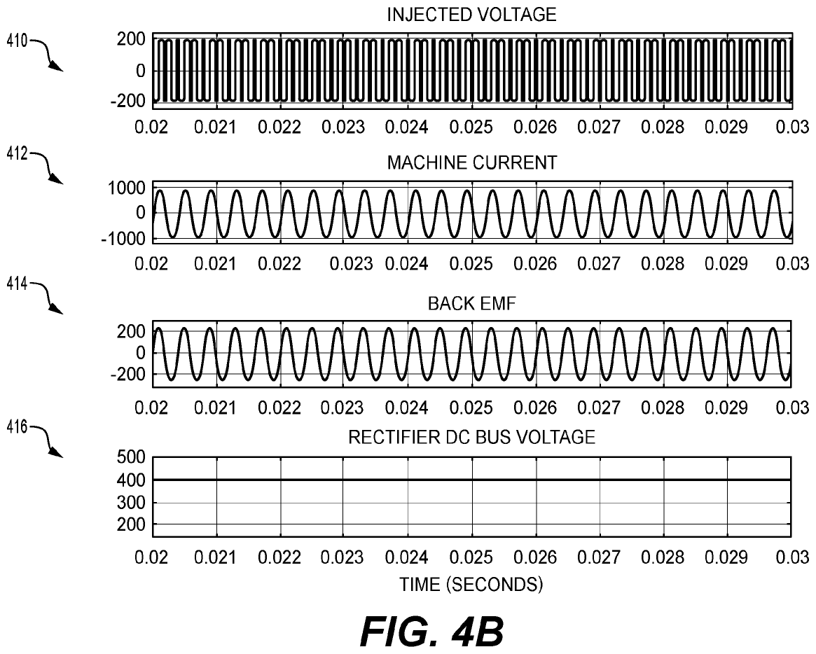

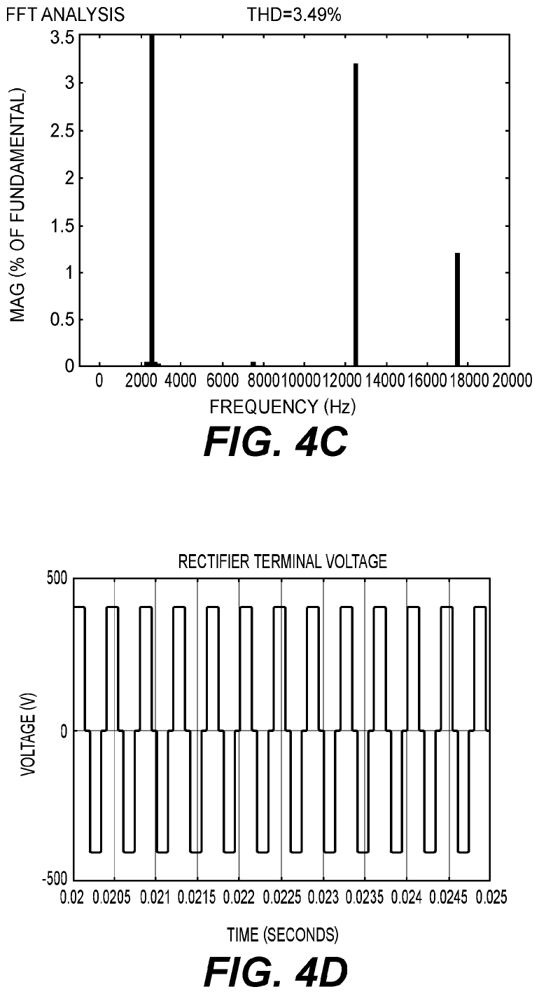

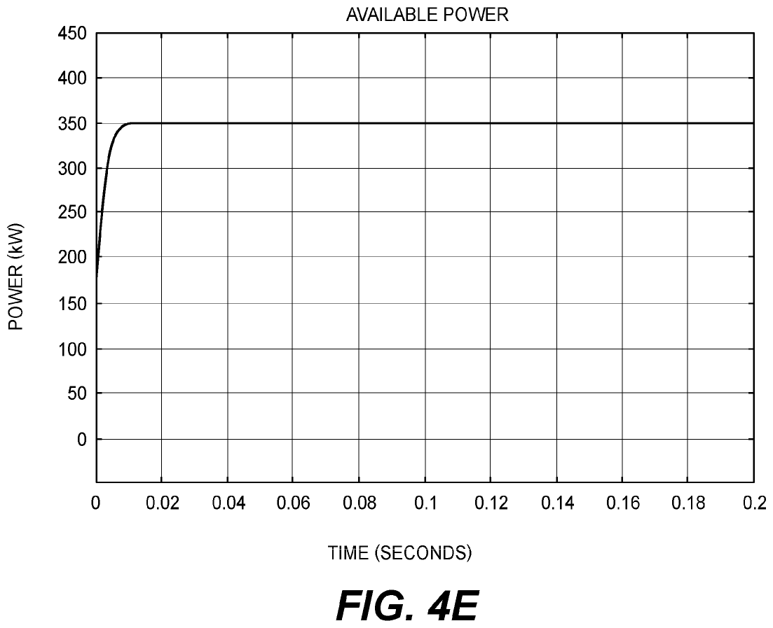

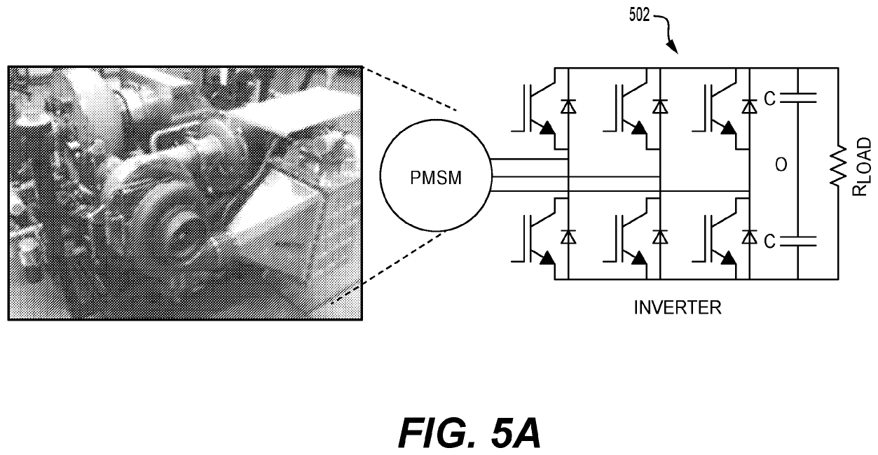

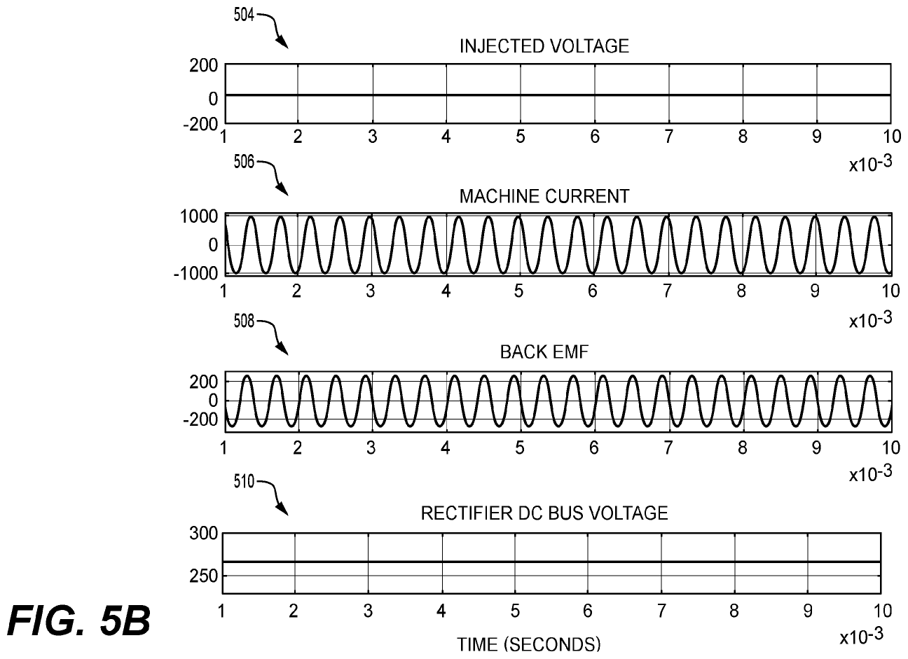

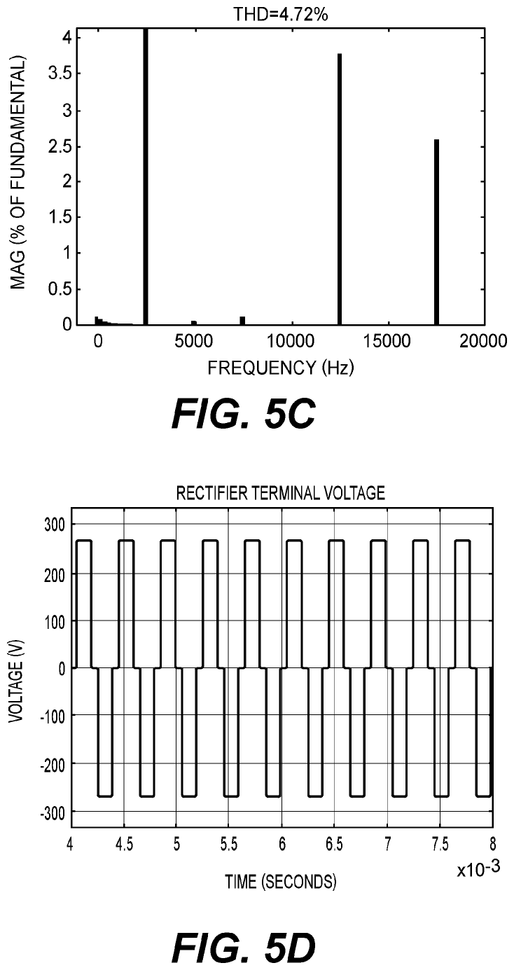

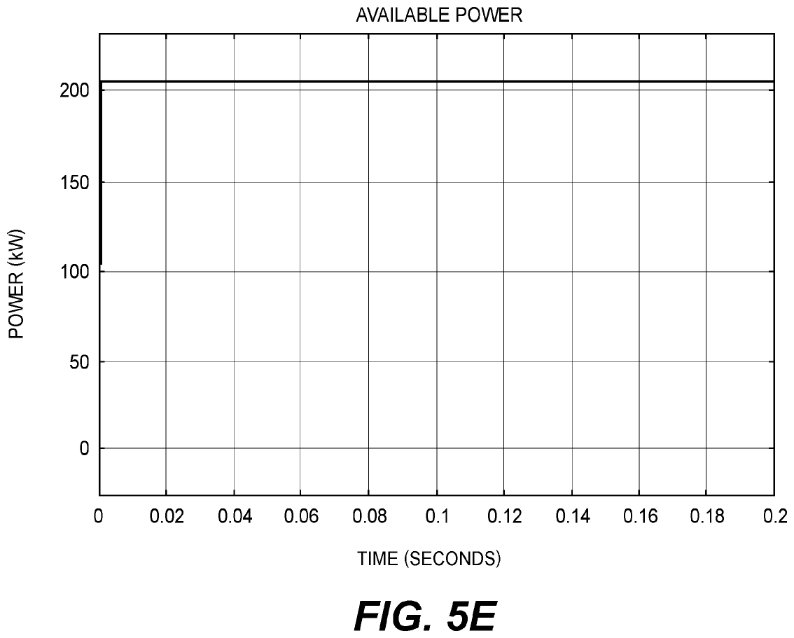

Two cases are shown for illustration purposes. A ‘Base Case’ is illustrated with zero injection, showing the performance of the PM generator with a simple diode bridge feeding a DC resistive load. FIGS. 4-5 show various waveforms of the system, including generator current, DC output voltage, back EMF, and rectifier terminal voltage. For the operating conditions, the DC voltage is seen to be 265 volts DC, and the maximum output power it can deliver is around 210 kW with a machine current of 850 Amps peak or 600 Amperes RMS. The machine's current output has a total harmonic distortion (THD) of 4.4%, which is considered acceptable.

### Base Case: 0 V Injection (=0%) (De Bus of the Power Converter) (i.e., OV De Bus Voltage of Power Converter at 210 KW of Rectifier Power)

With the circuit of FIG. 1, a simulation study has been performed, and the corresponding results are presented. FIG. 5A-5E shows results for a baseline case for a power converter (e.g., inverter) with no VAR injection, i.e., 0 V injection. FIG. 5A shows the power converter model 502, which corresponds to the inverter 106. FIG. 5B, plot 504 shows that the injected voltage into the scenario is 0V. Plot 506 shows the machine current; plot 508 shows the back EMF; and plot 510 shows the rectifier DC bus voltage. FIG. 5C shows the current THD of 4.72%. FIG. 5D shows the rectifier terminal voltage. FIG. 5E shows the maximum obtainable power with the rectifier load from the PMSM drive. As shown in FIG. 5E, the maximum available power without compensation is limited to approximately 210 KW.

### Case “1”: 180 V Injection at 350 kW of Rectifier Power

To increase the power obtainable from the PMSM drive to its rated value, a series compensator has been disclosed herein, and simulation studies based on MATLAB/Simulink have been performed to check the efficacy of the approach. FIG. 2A-2E shows results for a case in which 180V VAR is injected at 350 kW of the rectifier power. FIG. 2A shows the circuit schematic of the series compensation architecture for a series compensated PMSM. FIG. 2B, plot 206 shows that the injected voltage at +/−180V. Plot 508 shows the machine current; plot 510 shows the back EMF; and plot 512 shows the rectifier DC bus voltage. It can be observed that injected positive voltage is added to the falling waveform of the machine current and back EMF, and injected negative voltage is added to the rising waveform of the machine current and back EMF.

In plot 512, it can be observed that the DC bus voltage is about 400V, which is much higher than the bus voltage of 270V output by the power converter of FIG. 5. FIG. 2C shows the current THD of 4.72%. FIG. 2D shows the rectifier terminal voltage. FIG. 2E shows the maximum obtainable power with the rectifier load from the PMSM drive. As shown in FIG. 2E, the maximum available power without compensation is limited to approximately 350 KW (as compared to 210 kW without compensation shown in FIG. 5E).

Indeed, with the new injected compensation, the rectifier side power was able to deliver 350K W, significantly higher than the 210 kW possible without compensation with zero compensation. This is achieved with a power converter that is rated at 150 kVA, as opposed to 500 kVA, and switches at around 1/10^{th} the frequency of the conventional solution. This leads to significantly lower losses for the exemplary method and system, as opposed to a full-rated power converter. For the 350 KW system, the losses may decrease from 30 kW (9% losses) to around 7 kW (2% losses), which is a 75% reduction in converter losses.

### Case “2”: 200 V Injection at 350 KW of Rectifier Power with Modified Notch PWM Waveforms

To reduce the harmonic content in the machine current, the controller 119 may generate a modified square wave injection having notches that can be voltage injected to reduce the overall THHO and certain harmonics. FIG. 4A shows an example of the modified square wave injection scheme. The modified square wave includes an “on” portion 402 and an “off” portion 404, each having a respective “off” notch 406 or “on” notch 408 therein to address specific harmonics.

FIG. 4B-4E shows results for the case in which 200V VAR is injected at 350 kW of the rectifier power. FIG. 4B, plot 402 shows that the injected voltage at +/−200V. Plot 410 shows the injected voltage with notches (employed for the simulation); plot 412 shows the machine current; plot 414 shows the back EMF; and plot 416 shows the rectifier DC bus voltage. FIG. 4C shows the current THD of 3.79%. FIG. 4D shows the rectifier terminal voltage. FIG. 4E shows the maximum obtainable power with the rectifier load from the PMSM drive.

It can be observed that the exemplary series compensated PMSM with the modified injected voltage has a reduction in the overall THD with a significant reduction in the 5th and 7th harmonics (FIG. 4C). The current THD is reduced to 3.4% with the addition of the notches to the waveform. Also, it can be observed that the power obtainable after the addition of the notches remains at the rated 350 KW for the machine, as shown in FIG. 4E.

The modified PWM with notches may be generated using a Selected Harmonic Elimination (SHE) PWM, a Space-Vector PWM, an Instantaneous current control PWM, a Hysteresis band current control PWM, a Sigma-delta modulation, etc. Another example method to generate the PWM with notch output is described in U.S. Pat. No. 4,245,290.

### Example Computing System

It should be appreciated that the logical operations described above can be implemented (1) as a sequence of computer-implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, acts, or modules. These operations, acts and/or modules can be implemented in software, in firmware, in special purpose digital logic, in hardware, and any combination thereof. It should also be appreciated that more or fewer operations can be performed than shown in the figures and described herein. These operations can also be performed in a different order than those described herein.

In its most basic configuration, the controller (e.g., 119) can include at least one processing unit and system memory configured to execute in a real-time control loop. Depending on the exact configuration and type of computing device, system memory may be volatile (such as random-access memory (RAM)), non-volatile (such as read-only memory (ROM), flash memory, etc.), or some combination of the two. The processing unit may be a standard programmable processor that performs arithmetic and logic operations necessary for the operation of the computing device. As used herein, processing unit and processor refers to a physical hardware device that executes encoded instructions for performing functions on inputs and creating outputs, including, for example, but not limited to, microprocessors (MCUs), microcontrollers, graphical processing units (GPUs), and application-specific circuits (ASICs). Thus, while instructions may be discussed as executed by a processor, the instructions may be executed simultaneously, serially, or otherwise executed by one or multiple processors. The computing device may also include a bus or other communication mechanism for communicating information among various components of the computing device.

The computing device may have additional features/functionality. For example, the computing device may include additional storage, such as removable storage and non-removable storage. The computing device may also contain network connection(s) that allow the device to communicate with other devices, such as over the communication pathways described herein.

The processing unit may be configured to execute program code encoded in tangible, computer-readable media. Tangible, computer-readable media refers to any media that is capable of providing data that causes the computing device (i.e., a machine) to operate in a particular fashion. Various computer-readable media may be utilized to provide instructions to the processing unit for execution. Example of tangible, computer-readable media may include, but is not limited to, volatile media, non-volatile media, removable media, and non-removable media implemented in any method or technology for storage of information such as computer-readable instructions, data structures, program modules, or other data. System memory, removable storage, and non-removable storage are all examples of tangible computer storage media.

In an example implementation, the processing unit may execute program code stored in the system memory. For example, the bus may carry data to the system memory, from which the processing unit receives and executes instructions. The data received by the system memory may optionally be stored on the removable storage or the non-removable storage before or after execution by the processing unit.

### Example Artificial Intelligence and Machine Learning

As noted above, advanced techniques such as Neural Nets, a gradient method, or other AI techniques may be employed to find the lowest dissipation point, as well as various AI/ML techniques described herein. The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc., using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or target) during training with a labeled data set (or dataset). In an unsupervised learning model, the model learns a function that maps an input (also known as feature or features) to an output (also known as target or target) during training with an unlabeled data set. In a semi-supervised model, the model learns a function that maps an input (also known as feature or features) to an output (also known as target or target) during training with both labeled and unlabeled data.

### Neural Networks

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as an input layer, output layer, and optionally one or more hidden layers. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike a traditional neural networks, each layer in a CNN has a plurality of nodes arranged in three dimensions (width, height, and depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks. GCNNs are CNNs that have been adapted to work on structured datasets such as graphs.

### Other Supervised Learning Models:

A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

An Naïve Bayes' (NB) classifier is a supervised classification model that is based on Bayes' Theorem, which assumes independence among features (i.e., presence of one feature in a class is unrelated to presence of any other features). NB classifiers are trained with a data set by computing the conditional probability distribution of each feature given label and applying Bayes' Theorem to compute the conditional probability distribution of a label given an observation. NB classifiers are known in the art and are therefore not described in further detail herein.

A k-NN classifier is a supervised classification model that classifies new data points based on similarity measures (e.g., distance functions). K-NN classifiers are trained with a data set (also referred to herein as a “dataset”) to maximize or minimize an objective function, for example, a measure of the k-NN classifier's performance, during training. This disclosure contemplates that any algorithm that finds the maximum or minimum of the objective function can be used. k-NN classifiers are known in the art and are therefore not described in further detail herein.

An majority voting ensemble is a meta-classifier that combines a plurality of machine learning classifiers for classification via majority voting. In other words, the majority voting ensemble's final prediction (e.g., class label) is the one predicted most frequently by the member classification models. Majority voting ensembles are known in the art and are therefore not described in further detail herein.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as hard drives or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications as listed below and throughout this document are hereby incorporated by reference in their entirety herein.
[1] Monica Chinchilla, Santiago Arnaltes and Juan Carlos Burgos. “Control of Permanent-Magnet Generators Applied to Variable-Speed Wind-Energy Systems Connected to the Grid,” IEEE Transactions on Energy Conversion, Vol. 21, 0. 1, March 2006, pp. 130-135.
[2] Charles Maria Jenisha, Nanjappagounder Ammasaigounden, Natarajan Kumaresan, Kadi BhagyaSri, “Power electronic interface with de-coupled control for wind-driven PMSG feeding utility grid and DC load,” Power Electronics !ET, vol. 11, no. 2, pp. 329-338, 2018.
[3] F. Morel, L. Xuefang, J.-M Retif, B. Allard, C. Buttay, “A Comparative Study of Predictive Current Control Schemes for a Permanent-Magnet Synchronous Machine Drive,” IEEE Transactions on Industrial Electronics, vol. 56, No.7, pp. 2715-2728, 2009.
[4] L.A.C. Lopes, G. Joos, “Pulse width modulated capacitor for series compensation,” Power Electronics IEEE Transactions on, vol. I 6, no. 2, pp. 167-174, 200 I.
[5] J. Kuang and B. T. Ooi, “Series Connected Voltage-Source Converter Modules for Force-Commutated SVC and DC-Transmission,” IEEE Trans. Power Delivery, Vol. 9, no. 2, pp. 977-981, 1994.
[6] L. Gyugyi, “Dynamic Compensation of Ac Transmission Lines by Solid State Synchronous Voltage Sources,” IEEE Trans. Power Delivery, no. 9, pp. 904-911, 1994.
[7] L. Gyugyi, C. D. Schauder, and Kelyan K. Sen, “Static Synchronous Series Compensator: A solid-State Approach to the Series Compensation of Transmission Lines,” IEEE Trans. on Power Delivery, Vol. 12, no. 1, pp. 406-417, 1997.

1. A system comprising:
a rectifier configured to couple to each phase output of a high-speed machine generator to convert AC electrical power outputted from the machine to a DC output; and
a series compensated power conditioner coupled to the rectifier and the high-speed machine generator, the series compensated power conditioner comprising a power converter coupled in series to the high-speed machine generator through a series transformer to inject reactive power (VARs) into each phase output of the high-speed machine generator.

2. The system of claim 1, wherein the series compensated power conditioner provides leading reactive power to the high-speed machine to reduce reactive power loss.

3. The system of claim 1 further comprising:
a controller configured to direct the power converter to inject a leading voltage to a machine reactance for each phase output of the high-speed machine generator.

4. The system of claim 1, wherein the series transformer comprises a coaxial winding transformer (CWT), the coaxial winding transformer includes a multi-turn winding enclosed by a single-turn primary winding structure.

5. The system of claim 4, wherein each phase output of the power converter is connected in series to the multi-turn winding, and each phase output of the high-speed machine generator is connected in series to the rectifier through the single-turn primary winding structure.

6. The system of claim 1, wherein the rectifier comprises a diode bridge rectifier.

7. The system of claim 6, wherein the rectifier further comprises an LC filter.

8. The system of claim 3, wherein the controller is configured to generate a notched pulse-width-modulation (PWM) output to reduce harmonic distortion for pre-defined harmonics.

9. The system of claim 1, wherein the high-speed machine generator is selected from the group consisting of a wound-field synchronous machine, a switched reluctance machine, a permanent magnet machine, and a permanent magnet synchronous motor machine.

10. The system of claim 1, wherein the high-speed machine generator is a single-phase output machine.

11. The system of claim 1, wherein the high-speed machine generator is a three-phase output machine.

12. A method comprising:
converting, via a rectifier, AC electrical power outputted from each phase output of a high-speed machine generator to a DC output; and
injecting reactive power (VARs) through a series transformer into each phase output of the high-speed machine generator via a series compensated power conditioner coupled to the rectifier and the high-speed machine generator, the series compensated power conditioner comprising a power converter coupled in series to the high-speed machine generator through the series transformer.

13. The method of claim 12, wherein the series compensated power conditioner provides leading reactive power to the high-speed machine to reduce reactive power loss.

14. The method of claim 12 wherein the reactive power is injected as a leading voltage to a machine reactance for each phase output of the high-speed machine generator.

15. The method of claim 12, wherein the series transformer includes a multi-turn secondary winding having N windings that is proximal to a primary winding structure having less than N windings.

16. The method of claim 15, wherein each phase output of the power converter is connected in series to the secondary multi-turn winding, and each phase output of the high-speed machine generator is connected in series to the rectifier through the primary winding structure.

17. The method of claim 12, wherein the rectifier comprises a diode bridge rectifier and an LC filter.

18. The method of claim 13, wherein the leading reactive power is injected as a pulse-width-modulation (PWM) output or a notched PWM output.

19. The method of claim 12, wherein the high-speed machine generator is selected from the group consisting of a wound-field synchronous machine, a switched reluctance machine, a permanent magnet machine, and a permanent magnet synchronous motor machine.

20. The method of claim 12, wherein the high-speed machine generator is a single-phase output machine or a three-phase output machine.
